(19) United States
(12) Patent Application Publication
(10) Pub. No.: US 2026/0350949 A1
(43) Pub. Date: Nov. 5, 2026

(54) System and Method for Improving a Digital 3D Surface

(71) Applicant: 3SHAPE A/S, Copenhagen K (DK)

(72) Inventors: Isak MOTTELSON, Copenhagen K (DK); Henrik ÖJELUND, Copenhagen K (DK)

(73) Assignee: 3SHAPE A/S, Copenhagen K (DK)

(21) Appl. No.: 19/488,020

(22) PCT Filed: May 23, 2024
(86) PCT No.: PCT/EP2024/064269

§ 371 Date: Nov. 25, 2025

(30) Foreign Application Priority Data
May 25, 2023 (DK) PA202370252
Jun. 29, 2023 (DK) PA202370346

(51) Int. Cl. G06T 19/20; A61C 9/00; A61C 13/34; G06T 15/06; G06T 15/08; G06T 15/20; G06T 17/20

(52) U.S. Cl. CPC G06T 19/20; A61C 9/006; A61C 13/34; G06T 15/06; G06T 15/08; G06T 15/20; G06T 17/20; G06T 2210/41; G06T 2219/2004; G06T 2219/2016

(57) ABSTRACT

The present disclosure relates to a 3D scanner system including an intraoral 3D scanner including: a projector unit including a light source and a pattern generating element for structuring light into a pattern to be projected onto a surface of an object; and two or more cameras configured for acquiring a set of images, which include an image from each camera, each image including an array of pixels having a pixel color. The system further includes one or more processors operatively connected to the scanner and configured for: generating a 3D surface of the object based on the set of images, the 3D surface including a plurality of points/vertices; and generating a refined 3D surface by solving an optimization problem, wherein the points/vertices are repositioned such that, for each point/vertex, a metric based on the difference in the pixel colors associated with that point/vertex, is minimized.

### TECHNICAL FIELD

The present disclosure relates to a system and method for generating a three-dimensional (3D) surface of an object. In particular, the present disclosure relates to a system and method for improving or refining a three-dimensional (3D) surface, e.g., in terms of accuracy or detail level.

### BACKGROUND

3D scanning is the process of analyzing a real-world object or environment to collect three-dimensional data of its shape and possibly its appearance (e.g. color). The collected data can then be used to construct a digital 3D model. A 3D scanner can be based on many different technologies such as depth from focus, depth from defocus, triangulation, stereo vision, optical coherence tomography (OCT), structure from motion, time of flight, among others.

Typically, the digital 3D model is reconstructed from multiple 3D representations or surfaces, sometimes referred to as sub-scans, which are brought into a common reference system, a process that is usually called alignment or registration, and then merged to create the complete 3D model of the scanned object. The sub-scans are typically acquired from different views of the object. The whole process, going from single sub-scans to the complete 3D model, is sometimes known as a 3D scanning pipeline.

Sometimes the single 3D surfaces, or sub-scans, suffer from a bias. An example of a bias could be in terms of depth, e.g., if the determined depth of the object is erroneous and skewed from the ground truth. This could imply that some areas of the 3D surface are erroneous in terms of depth, which consequently can lead to an inaccurate 3D model.

Thus, it is of interest to develop an improved system and method for refining 3D surfaces, e.g. by removing the aforementioned bias, such that multiple such refined 3D surfaces can be merged to generate a more accurate digital 3D model. Furthermore, it is desired to enhance the detail level of 3D surfaces. A high accuracy and/or a high detail level is desired for many applications, for instance within digital dentistry, wherein a digital impression of a person's teeth is generated.

### SUMMARY

The present disclosure addresses the above-mentioned challenges by providing a system and method for enhancing or refining the accuracy and/or the detail level of a 3D representation, such as a 3D surface, based on pixel data, such as color data of the pixels, from images acquired by two or more cameras. In particular, the present disclosure addresses and solves the above-mentioned challenges by providing a 3D scanner system comprising:
an intraoral 3D scanner comprising:
   a projector unit comprising a light source and a pattern generating element for structuring light from the light source into a pattern to be projected onto a surface of an object, such as at least a part of a person's teeth;
   two or more cameras operatively connected to the projector unit, the cameras being configured for acquiring a set of images, wherein the set of images comprises an image from each camera, wherein each image comprises an array of pixels, each pixel having a pixel color cᵢ;
zone or more processors operatively connected to the intraoral 3D scanner, said processors configured for:
   generating a three-dimensional (3D) surface of the object based on the set of images obtained from the cameras, wherein the 3D surface comprises a plurality of points and/or vertices; and
   generating a refined 3D surface by solving an optimization problem, wherein points and/or vertices in the 3D surface are repositioned such that, for each point or vertex, a metric based on the difference in the pixel colors cᵢ associated with that point or vertex, is minimized.

In accordance with some embodiments, the 3D scanner system comprises:
an intraoral 3D scanner comprising:
   a projector unit comprising a light source and a pattern generating element for structuring light from the light source into a pattern to be projected onto a surface of an object;
   two or more cameras operatively connected to the projector unit, the cameras being configured for acquiring a set of images, wherein the set of images comprises an image from each camera;
one or more processors operatively connected to the intraoral 3D scanner, said processors configured for:
   generating a three-dimensional (3D) surface of the object based on the set of images obtained from the cameras; and
   generating, for each pixel in each image within the set of images, a camera ray emanating from the pixel to the 3D surface, thereby generating a plurality of camera rays incident on the 3D surface; and
   generating a virtual image by projecting each of the camera rays from the respective incidents on the 3D surface to a projector image plane.

The present disclosure further relates to a computer-implemented method comprising the steps of:
generating a three-dimensional (3D) surface of an object, wherein the 3D surface is generated based on a set of images obtained from two or more cameras, wherein the set of images comprises at least one image from each of the cameras, wherein each image comprises an array of pixels, each pixel having a pixel color cᵢ;
generating, for each image, a camera ray emanating from each pixel to the 3D surface, thereby generating a plurality of camera rays incident on the 3D surface;
generating, for each image, a projector image by projecting each of the camera rays from the respective incidents on the 3D surface to a predefined projector image plane, wherein the projector image comprises a plurality of projector image pixels each having a pixel color cₚ based on the pixel colors cᵢ;
determining, for each projector image pixel, a metric expressing the difference of the pixel colors cₚ across the projector images; and
generating a modified 3D surface by translating one or more points and/or vertices of the 3D surface, such that one or more cost functions associated with the projector image pixels are minimized.

In accordance with some embodiments, the computer-implemented method comprises the steps of:
generating a three-dimensional (3D) surface of an object, wherein the 3D surface is generated based on a set of images obtained from two or more cameras, wherein the set of images comprises at least one image from each of the cameras, wherein each image comprises an array of pixels, each pixel having a pixel color cᵢ;
defining a projector image plane having a predefined pattern;
generating, for each pixel in each image within the set of images, a camera ray emanating from the pixel to the 3D surface, thereby generating a plurality of camera rays incident on the 3D surface;
generating a projector image comprising a plurality of projector image pixels, each having a pixel color cₚ, wherein the projector image is generated by projecting each of the camera rays from the respective incidents on the 3D surface to the projector image plane;
determining, for each projector image pixel, the variance of pixel colors, cᵢ, contributing to the pixel color, cₚ, of said projector image pixel; and
modifying the 3D surface by changing the position of one or more points and/or vertices of the 3D surface, such that one or more cost functions associated with the projector image pixels are minimized.

The computer-implemented method may be implemented on the 3D scanner system disclosed herein. Accordingly, the 3D scanner system may comprise one or more processors configured for executing, either fully or partly, any of the embodied computer-implemented methods disclosed herein.

Given a 3D representation, such as a 3D surface, of a real-world three-dimensional (3D) object, the presently disclosed system and method provides a framework for modifying and refining said 3D representation based on image data from multiple images, e.g. by comparing the pixel colors of pixels associated with similar 3D points in the representation. In preferred embodiments, this is achieved by first obtaining a three-dimensional (3D) surface of an object. The 3D surface may be given as the input to the presently disclosed computer-implemented method and/or it may be generated by a 3D scanner system as disclosed herein. As an example, an intraoral 3D scanner comprising two or more cameras may be utilized to generate a 3D representation based on a set of images acquired by the cameras. The 3D representation may be provided to a 3D scanner system comprising one or more processors configured for generating the 3D surface based on the 3D representation and/or based on the acquired set of images. In some embodiments, the 3D surface is represented as a mesh or a signed distance field.

The 3D surface may be generated based on the set of images comprising multiple images, such as at least one image per camera used to obtain the set of images. The points in the 3D surface may be determined by triangulation, i.e. by triangulating determined image features in the images in 3D space and determining their intersection with projector rays, said projector rays corresponding to pattern features being projected or ray traced in 3D space. Thus, the intraoral 3D scanner may comprise a projector unit configured for projecting a pattern onto the surface of the scanned 3D surface. In general, the 3D resolution of the reconstructed 3D surface, i.e., the number of 3D points in the surface, correlates with the density of the projected pattern, i.e., the number of pattern features. In some cases, a high-density pattern is projected, e.g. a pattern comprising at least 3000 pattern features. A pattern with a high number of pattern features generally increases the complexity of the correspondence problem, i.e. the problem of associating each image feature with a projector ray. This can lead to an ambiguity when determining the 3D points by triangulation. The ambiguity may further lead to the aforementioned bias in terms of depth.

Given the 3D surface, the disclosed method may comprise the step of projecting image pixels in the acquired images into 3D space and determining their intersection with the 3D surface. Said projection may also be referred to herein as ray tracing. When ray tracing a given image pixel, the ray may emanate from a single point of the camera, also referred to as the focal point or aperture of the camera, and through the given image pixel located in the image plane of said camera. This ray tracing may be performed for all image pixels in the acquired images, whereby a plurality of camera rays are generated in 3D space, said camera rays being incident on or intersecting the 3D surface, such as the 3D mesh. Said intersections may be determined and subsequently projected onto a virtual projector image placed in a predefined projector image plane. In some embodiments, multiple such virtual projector images are generated, e.g. one projector image per camera image in the set of images.

As an alternative to ray tracing, rasterization of the 3D surface may be performed or utilized. Rasterization is a common technique of rendering 3D models. Compared with other rendering techniques such as ray tracing, rasterization is very fast and therefore often used in real-time 3D engines. Rasterization may be understood as the process of computing the mapping from surface geometry to pixels. The 3D surface may be represented as a polygon mesh, such as a triangular mesh composed of a plurality of triangular vertices. Thus, the disclosed method may comprise the step of rasterizing one or more of such vertices. The vertices may undergo various transformations, such as model transformation, view transformation, projection transformation, and/or combinations thereof. These transformations may position each vertex in the appropriate location and convert it from 3D world coordinates to 2D screen coordinates. The entire mesh of the 3D surface may be rasterized and rendered as a series of pixels, creating a 2D representation of the 3D object.

The disclosed method may comprise the step of modifying the 3D surface by translating one or more points and/or vertices in the 3D surface, whereby one or more modified surfaces, such as N modified surfaces, are obtained. The step of modifying the 3D surface may alternatively be performed prior to the aforementioned ray tracing of image pixels and generation of the virtual projector images. The points or vertices of the 3D surface may be translated along straight lines, such as along lines of sight from the projector unit. In other words, the method may comprise the step of generating one or more modified 3D surfaces, such as variations of the originally input 3D surface. The modified surfaces may in some cases be understood as either contractions or expansions of the original 3D surface.

Subsequent to generating said N modified 3D surfaces, the step of ray tracing image pixels from the camera images and onto the surface and into the virtual projector image(s) may be performed for all modifications of the 3D surface. Accordingly, a plurality of virtual projector images may be generated, such as one per camera per modification. Then, for each projector image pixel, the mean and/or variance of the color may be determined across the projector images. This may be done for all modifications of the originally input 3D surface. In particular, the method may comprise the step of determining, for each projector image pixel, a metric expressing the difference of the pixel colors across the projector images. The metric may be selected from the group of: standard deviation, variance, coefficient of variation, or combinations thereof, or other similar metrics suitable for expressing deviations or differences within a data set. Furthermore, an averaged projector image may be generated for each modification. All projector images may be used to generate said averaged projector image.

The method may comprise the step of generating one or more cost functions associated with the projector image pixels. In some embodiments, at least one cost function is generated for each pattern feature in a pattern visible in the projector image(s). The pattern may be generated by a pattern generating element, such as a mask, forming part of the projector unit. Thus, in that case, a corresponding or similar pattern will appear in the acquired images, and also appear in the corresponding virtual projector images. The method may comprise the step of calculating a pixel-wise product of the pattern and the averaged projector image. Accordingly, in some cases a cost function is defined or generated for each pattern feature in the projector images. The cost function may include a weighted sum of the aforementioned metric and/or pixel-wise product.

The method may comprise the step of solving an optimization problem wherein the generated cost functions are minimized for each projector image pixel to determine the optimum depths of the 3D surface. Thereby, a refined or optimized 3D surface may be output by the system and method. The refined 3D surface may be optimized particularly in terms of the depth of the points and/or vertices forming part of the 3D surface, whereby a more enhanced and/or accurate resulting 3D model can be reconstructed from a plurality of such 3D surfaces. In particular, the disclosed method is efficient in minimizing or removing bias in terms of depth as evident from FIG. 7. Further details of the system and method can be found in the detailed description herein.

The present disclosure further relates to a data processing system, such as the 3D scanner system disclosed herein, comprising one or more processors configured to perform one or more of the steps of the computer-implemented method disclosed herein.

The present disclosure further relates to a computer program product comprising instructions which, when the program is executed by a computer, cause the computer to carry out the steps of the method disclosed herein. The present disclosure further relates to a computer-readable data carrier having stored thereon said computer program product.

The present disclosure further relates to a computer-readable storage medium comprising instructions which, when executed by a computer, cause the computer to carry out the steps of the method disclosed herein.

Summarizing, the presently disclosed 3D scanner system and the associated computer-implemented method provide a novel and improved framework for generating and refining 3D surfaces; said framework being particularly suitable for applications within digital dentistry, such as digital impressions of teeth or other dental objects.

### BRIEF DESCRIPTION OF THE DRAWINGS

FIG. 1 shows a 3D scanner system according to the present disclosure.

FIGS. 2-4 shows flowcharts according to different embodiments of the computer-implemented method disclosed herein.

FIG. 5 shows a computer system in which embodiments of the present disclosure, or portions thereof, may be implemented as computer-readable code.

FIG. 6 shows an exemplary illustration of the presently disclosed computer-implemented method.

FIG. 7 shows a generated 3D surface, i.e., a single sub-scan, before and after modification/refinement of the surface.

### DETAILED DESCRIPTION

A first step of the presently disclosed method may be to obtain or generate a three-dimensional (3D) surface of an object. The object may be a dental object, such as at least a part of one or more teeth of a subject, such as a person. Other examples of dental objects include: teeth, gingiva, implant(s), dental restoration(s), dental prostheses, edentulous ridge(s), and/or combinations thereof. The 3D surface may also be referred to herein as a 3D representation or a sub-scan. The 3D surface may be generated based on a set of images obtained from multiple cameras, e.g. forming part of an intraoral 3D scanner. The intraoral 3D scanner may be a handheld 3D scanner for acquiring images and/or sub-scans inside the oral cavity of a subject.

The 3D surface may be represented as a three-dimensional mesh, such as a polygon mesh, a signed distance field, a voxel grid, an implicit surface function, a B-spline surface, or other suitable data structures for representing a 3D surface. The 3D mesh, e.g. the polygon mesh, may comprise a plurality of vertices connected at their edges. The mesh may further comprise a plurality of points. In some embodiments, the 3D surface is represented as a triangle mesh comprising a collection of triangular vertices connected by their common edges. Several methods exist for mesh generation, including the marching cubes algorithm. Accordingly, the presently disclosed system and method may employ one or more methods or algorithms for mesh generation, such as marching cubes, Delaunay triangulation, advancing front method, quadtree/octree subdivision, or isosurface extraction.

The 3D surface or sub-scan may be generated by an intraoral 3D scanner, which may form part of a 3D scanner system as disclosed herein. The 3D scanner system may be configured to continuously generate a plurality of 3D surfaces in real-time during operation. In some embodiments, the intraoral 3D scanner is configured to generate a 3D representation of the scanned surface of the object, where the 3D representation is a point cloud. The 3D scanner system may comprise one or more processors, operatively coupled to the intraoral 3D scanner, wherein said processor(s) are configured for generating a 3D surface, e.g. in the form of a polygon mesh, based on the point cloud generated by the intraoral 3D scanner. In other embodiments, the 3D surface is generated entirely by the intraoral 3D scanner.

The 3D scanner system may be configured to register a plurality of such 3D surfaces or sub-scans to each other in a process known as registration, whereby the sub-scans are brought into a common reference system. The 3D surfaces may be stitched together to form a complete 3D model of the object. The 3D model may be a digital impression of a person's dentition. Typically, each 3D surface corresponds to a single field of view of the intraoral 3D scanner. Thus, by stitching multiple of such 3D surfaces, it is possible to reconstruct a 3D model with a surface larger than what can be captured in a single field of view. The steps of registration and/or stitching may be performed in real-time by the 3D scanner system.

In preferred embodiments, the 3D surface is generated based on a set of images obtained from two or more cameras. The cameras may be integrated in an intraoral 3D scanner as disclosed herein. The cameras may be arranged in a fixed known relationship with at least one projector unit. Each camera may have a given predefined field of view, such as selected from about 50°-115°, such as from about 65°-100°, preferably from about 65°-85°. In some embodiments, the cameras of the 3D scanner have overlapping fields of view such that the cameras view or image substantially the same part or surface of the object. The intraoral 3D scanner may be based on a triangulation scanning principle; thus, each camera may define an angle with respect to the projector unit. A triangulation-based intraoral 3D scanner is further described in the following applications by the same applicant: PCT/EP2022/086763 “Systems and methods for generating a digital representation of a 3D object” filed on 19 Dec. 2022, PCT/EP2023/058521 “Intraoral 3D scanning device for projecting a high-density light pattern” filed on 31 Mar. 2023, and PCT/EP2023/058980 “Intraoral scanning device with extended field of view” filed on 5 Apr. 2023, which are incorporated herein by reference in their entirety.

In some embodiments, the set of images comprises at least one image from each of the cameras, such as exactly one image from each of the cameras. As an example, in case the intraoral 3D scanner comprises four cameras, the set of images may include four images, wherein each image is acquired from a unique camera, such that each camera contributes with one image to the set of images. The cameras may be symmetrically arranged around an optical axis defined by the projector unit; and they may define similar angles to said optical axis.

The projector unit may comprise or constitute a digital light processing (DLP) projector using a micro mirror array for generating a time varying pattern, or a diffractive optical element (DOE), or a front-lit reflective mask projector, or a micro-LED projector, or a liquid crystal on silicon (LCOS) projector or a back-lit mask projectors, wherein a light source is placed behind a mask having a spatial pattern. The projector unit may comprise a light source for emitting light and a pattern generating element for structuring light from the light source into a pattern. In some embodiments, the projector unit further comprises one or more collimation lenses for collimating the light from the light source before it is transmitted through a mask having a spatial pattern. The light source of the projector unit may be configured for emitting light in a visible wavelength range, such as enabled by utilizing a white light source. An advantage of utilizing white light is that color (texture) and 3D information may be inferred from the same set of image frames, i.e. from a single set of images.

In some embodiments, the virtual image described herein is a color image generated based on visible light reflected from the surface of the object. In other embodiments, the virtual image is generated based on infrared light reflected from the object. The infrared light may be provided by one or more additional infrared (IR) or near-infrared (NIR) light sources configured for emitting infrared light, such as light having a wavelength or having a range of wavelengths selected from the range of about 700 nm to about 1.5 μm. The infrared light may penetrate into the tooth/teeth such that one or more internal regions of the tooth/teeth are visualized in the virtual image. The virtual image may be a synthesized image having a novel view (location and/or orientation) compared to the views of the cameras being used to generate said virtual image.

The images obtained by the cameras may be two-dimensional (2D) images. Each image may comprise an array of pixels, e.g. arranged as rows and columns in the array, wherein each pixel has a pixel color cᵢ in the image. The pixel color may be given by one or more intensity values, such as three intensity values corresponding to red, green, and blue intensity (RGB values). The pixel color may be obtained from one or more color channels on the image sensor. Thus, in some embodiments, the image sensor is a color image sensor comprising one or more color channels. In some embodiments, a color filter array, such as a Bayer filter, is arranged over the array of pixels.

The presently disclosed method may comprise the step of defining a projector image plane having a predefined pattern. The projector image plane may be understood as a virtual image plane. In some embodiments, the intraoral 3D scanner comprises a back-lit mask projector unit, wherein the mask comprises a spatial pattern, which can be projected onto a surface of the scanned object. In some embodiments, the projector image plane is coinciding with the location of the mask. However, this is not necessary. The projector image plane could be in another location, where it is possible to determine the projected pattern on the plane. In some embodiments, the location of the virtual image plane is different from the location of the image planes belonging to the images in the set of images. In some embodiments, the projected pattern is generated by a diffractive optical element (DOE). The projected pattern may be a static pattern or a dynamic pattern, i.e. such that the pattern changes over time. Teeth typically have large regions with little variation in color and geometry, which often complicates 3D reconstruction of the surface of the teeth. An advantage of projecting a pattern onto the surface of teeth is that it forms more contrast on the surface of the teeth, thus making reconstruction more feasible.

The presently disclosed method may comprise the step of generating, preferably for each pixel in each image within the set of images, a camera ray emanating from the pixel to the 3D surface, thereby generating a plurality of camera rays incident on the 3D surface. Thus, each pixel may be associated with a corresponding camera ray in three-dimensional (3D) space originating from said pixel. A camera ray may be generated for a plurality of the pixels in one or more of the images within the set of images. In some embodiments, a camera ray is generated for each pixel in each of the images within the set of images. Each camera may be mathematically approximated by a pinhole camera model with a given camera aperture and focal length. The model may define an image plane, where a 3D object or scene is projected through the aperture of the camera. The image plane may be located at a distance f (focal length) from the aperture of the pinhole camera. Ray tracing a given image pixel may be understood as projecting a straight line from the focal point of the camera through said image pixel, wherein said line can be extended indefinitely in 3D space along said direction. A similar model may be utilized for the projector unit. In some cases, the mathematical model for the camera(s) and/or the projector unit further takes into account geometric distortions and/or blurring of unfocused objects caused by lenses and finite sized apertures.

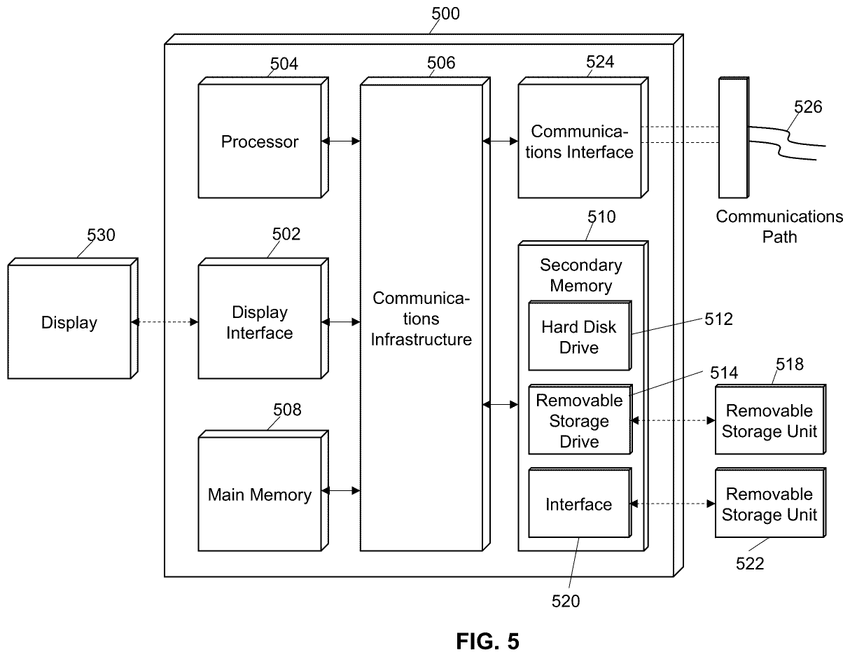

In other words, the method may comprise the step of projecting or ray tracing each pixel in the images onto the 3D surface and then onto the projector image plane, whereby one or more projector images may be generated in said plane, such as one projector image per camera image. This is illustrated for a single camera and projector image in FIG. 6. The projector images may be understood as being virtual projector images. It is advantageous if all pixels are utilized to refine the depth of the 3D surface; however, in some embodiments only a part of the pixels on the sensor(s) are utilized to correct the 3D surface. The method may comprise the step of determining intersections of the camera rays incident on the 3D surface. Specifically, each camera ray intersects the 3D surface at a given point, which may be determined by the presently disclosed system and method. Alternatively, or additionally, the method may comprise the step of determining intersections between camera rays; however, the camera rays may not intersect perfectly on the 3D surface, but rather intersect within some tolerance. The intersections, or incidents, may correspond to points on the 3D surface.

The presently disclosed method may comprise the step of generating one or more projector images by projecting each of the camera rays from the respective incidents, or intersections, on the 3D surface to the projector image plane. In some embodiments, a projector image is generated for each image in the set of images. The projector image(s) preferably lie in the projector image plane. The projector image(s) may comprise a plurality of projector image pixels, each having a pixel color cₚ. The pixel color may be defined by one or more intensity values, such as three intensity values corresponding to red, green, and blue intensity (RGB values). In general, the pixel colors cₚ in the projector image(s) are influenced by the pixel colors cᵢ observed in the camera images; however, they do not necessarily correspond 1:1. For instance, a given projector image pixel may have a color cₚ that is the result of some smoothing or interpolation of the colors of nearby pixels. As an example, if a given camera ray, associated with a given camera image pixel, is projected onto a given projector image pixel, then the resulting color, cₚ, of that pixel may have a color with a large contribution from that camera ray but it may also receive contributions from neighboring pixels.

The presently disclosed method may comprise the step of determining, preferably for each projector image pixel, a metric expressing the difference of the pixel colors, cᵢ. Examples of suitable metrics for expressing the difference are: standard deviation, variance, coefficient of variation, or combinations thereof. In general, the pixel color cᵢ of the pixels in the captured images will contribute to the pixel color cₚ in the projector image(s). In some embodiments, a given image pixel in the virtual image has a given color based on contributions from pixels in two or more images obtained from different cameras. The number of contributions to the pixel color cₚ depends on the number of cameras capturing the images in the set of images. In general, if there are more than one camera, such as two or more cameras, then the pixel colors cᵢ contributing to a given pixel color cₚ may be different; this difference may be evaluated and utilized to assess the validity of the depth of the 3D surface. Thus, each pixel color cₚ in the projector image(s) is the result of the contributions of different pixel colors cᵢ from the different images. As an example, in case of four cameras, i.e. four images in the set of images, then four image pixels having possibly different colors cᵢ, e.g., {c₁, c₂, c₃, c₄}, will contribute to each pixel color cₚ in the projector image(s). The method may comprise the step of averaging the colors cᵢ to generate the projector image(s) with pixel colors cₚ. Preferably, all images within the set of images are used to generate the averaged image. The method may further comprise the step of calculating the pixel-wise product of the predefined pattern and the averaged image. Thus, the averaged image may be multiplied, pixel-by-pixel, with the values of the predefined pattern.

The difference metric, such as the mean and/or variance, of said different colors cᵢ may be determined for each pixel in the projector image(s). Ideally, the image pixels contributing to a given point on the 3D surface should have the same color. Thus, if the generated or obtained 3D surface is perfect, i.e. corresponds to the ground truth, then all pixels colors cᵢ contributing to a given pixel color cₚ in the projector image(s) should have the same color. This would correspond to a situation where the 3D point associated with said pixel in the projector image(s) lies correctly on the 3D surface. Conversely, if the pixels colors cᵢ are not the same color this would imply that the 3D surface can be refined or corrected. Accordingly, the aforementioned metric expressing the difference of the pixel colors cᵢ may be determined and utilized to adjust the 3D surface until the metric is at a minimum. In some embodiments, the metric is the variance of the pixel colors cᵢ. The variance may be understood as the square of the standard deviation. The 3D surface may be adjusted by changing the position of one or more points and/or vertices of the 3D surface, e.g. by translating one or more vertices of the 3D surface in case this is represented as a polygon mesh. In particular, the 3D surface may be adjusted in order to minimize one or more cost functions, as further described below.

In some embodiments, a projector image is generated for each image in the set of images; thus, the number of projector images may correspond to the number of camera images or cameras. In other words, the method may comprise the step of generating pairs of a camera image and a corresponding projector image. In this case, the method may comprise the step of determining, preferably for each projector image pixel, a metric expressing the difference of the pixel colors cₚ across the projector images. As an example, in case of a 3D scanner having four cameras, the four cameras may be configured to acquire a set of four images, preferably simultaneously. Then, the disclosed computer-implemented method may comprise the step of, for each of said images, generating a projector image; thus, in this example four projector images are generated. Then, the difference of the colors of said four projector images may be determined, e.g. in terms of variance. The method may further comprise the step of generating an averaged projector image from the projector images. In some embodiments, each of the projector images comprises a pattern having a plurality of pattern features.

The presently disclosed method may further comprise the step of defining one or more cost functions associated with the projector image, or specifically with the projector image pixels. In some embodiments, at least one cost function is generated for each pattern feature in the pattern visible in the projector image(s). A cost function is also sometimes referred to as a loss function or an error function within mathematical optimization. In general, an optimization problem seeks to minimize a cost function. The cost function(s) may be minimized using finite differences or similar techniques. In some embodiments, the minimization is carried out iteratively such that the photo-consistency between the images is maximized. In the present disclosure, the cost function(s) may take one or more variables as input. An example of a suitable input variable includes the aforementioned metric, such as the mean and/or variance of the pixel colors cᵢ contributing to a given pixel color cₚ in the projector image(s). As another example, the method may comprise the step of determining the correlation between the predefined pattern and the corresponding observed or constructed pattern in the projector image(s). Ideally, these two patterns should be identical. In case the projector image(s) lies in the projector image plane, the pattern in said plane should be identical to the predefined pattern projected by the intraoral 3D scanner. Any deviations may indicate that the 3D surface can be optimized, refined, or corrected. Thus, some correlation measure may be defined to assess the similarity between said two patterns. This correlation can be used as an input variable to a cost function. In principle, there may be a cost function assigned to or associated with each pixel in the projector image(s). Alternatively, the method may comprise the step of defining a cost function for each feature in the predefined pattern. As an example, the predefined pattern may be a checkerboard pattern, wherein the features of the pattern correspond to the corners in the pattern, i.e. the corners of checkers within the checkerboard pattern. The purpose is then to optimize the 3D surface such that said cost functions are minimized, whereby a corrected and optimized 3D surface is obtained. The cost function associated with each pattern feature may include a weighted sum of e.g. the variance of the pixel colors cᵢ.

The presently disclosed method may comprise the step of modifying the 3D surface by changing, such as by translation, the position of one or more points and/or vertices of the 3D surface. The position of each point or vertex on the 3D surface may be varied and a position for each point or vertex may be chosen to minimize the value of the cost function in that point/vertex. In some embodiments, the position(s) may be constrained to move only in direction(s) along projector rays emanating from the projector image pixels. In other words, the position(s) may be varied along lines of sight from the projector unit, corresponding to expanding or contracting the surface along said lines.

The method for finding the position with the minimal value of the cost function may involve computing numerical derivatives of the cost function using finite difference methods or similar techniques. In other words, the cost function(s) may be minimized using gradient based techniques such as Newton's method or gradient descent methods. The gradients may be calculated analytically or estimated using finite differences. The method may utilize an iterative method for determining the minimum of the cost function(s), such as Newton's method, also referred to as the Newton-Raphson method. Newton's method is an iterative algorithm used to find the minimum of a cost function. The method approximates the cost function by a quadratic function and updates the input values based on the roots of the quadratic. The disclosed method may employ one or more iterations or executions of Newton's method in order to provide more than one optimization step. Alternatively, other methods or algorithms may be utilized, such as conjugate gradient methods, gradient descent methods, steepest descent methods, or Quasi-Newton methods, such as the Broyden-Fletcher-Goldfarb-Shanno (BFGS) algorithm.

The modified 3D surface associated with the determined minimum value of the cost function(s) may correspond to a refined version of the 3D surface originally input to the algorithm. Thus, the disclosed method may comprise the step of generating a refined 3D surface by solving an optimization problem, wherein points and/or vertices in the 3D surface are repositioned such that differences in the pixel colors cᵢ corresponding to similar points across the images are minimized. In some embodiments, the optimization problem is solved by repositioning or translating points and/or vertices in the 3D surface such that, for each point or vertex, a metric based on the difference in the pixel colors cᵢ associated with that point or vertex, is minimized. In some embodiments, the positions of all points and/or vertices in the 3D surface are iteratively changed such that the photo-consistency between images is maximized. One measure of the photo-consistency is the difference between the pixel colors cᵢ, such as the variance between said pixel colors. The method may further comprise the step of outputting the refined 3D surface based on an originally input 3D surface. The refined 3D surface may be stored in a memory device operatively coupled with the processor(s) of the 3D scanner system. The refined 3D surface may be stitched to an existing 3D model and/or stitched to a plurality of other 3D surfaces (also known as sub-scans), whereby a 3D model can be generated. Typically, said 3D model has a surface area larger than that of the individual 3D surfaces.

Accordingly, the presently disclosed method may comprise the step of solving an optimization problem, wherein the 3D surface is modified by changing the position of one or more vertices or points belonging to the 3D surface, wherein the 3D surface is modified such that one or more cost functions associated with the projector image(s) are minimized. Specifically, the cost function(s) may be associated to the aforementioned metric, e.g. the mean and/or variance of the pixel colors, and/or associated to the correlation of the patterns. A high variance of pixel colors may be associated with a high cost in the optimization problem, and a low correlation may similarly induce a high cost when solving the problem, e.g. using an iterative approach. Accordingly, the presently disclosed method provides a framework for optimizing a given 3D surface, in particular in terms of bias in depth, such that the optimized or refined 3D surface is less biased. Thereby, a more accurate and more detailed 3D model may be generated based on the refined 3D surfaces.

The 3D scanner system may comprise an intraoral 3D scanner as disclosed herein and one or more processors configured for performing one or more of the steps of the computer-implemented methods disclosed herein. The processor(s) may be selected from, or include one or more of: central processing units (CPU), graphics processing units (GPU), neural processing units (NPU), accelerators, microprocessors, application-specific integrated circuits (ASIC), field-programmable gate arrays (FPGA), dedicated logic circuitry, dedicated artificial intelligence processor units, and/or combinations thereof.

The 3D scanner system may further comprise computer memory such as random-access memory (RAM) or read-only memory (ROM). The processor(s) of the scanner system may be configured to read and execute instructions stored in the computer memory e.g. in the form of random-access memory. The computer memory may be configured to store instructions for execution by the processor(s) and data used by those instructions. As an example, the memory may store instructions, which when executed by the processor(s), cause the scanner system to perform, wholly or partly, any of the computer-implemented methods disclosed herein. The scanner system may further comprise a graphics processing unit (GPU). The GPU may be configured to perform a variety of tasks such as video decoding and encoding, rendering of the digital 3D model, and other image processing tasks.

The 3D scanner system may further comprise non-volatile storage in the form of a hard disc drive. The scanner system preferably further comprises an I/O interface configured to connect peripheral devices used in connection with the scanner system. More particularly, a display may be connected and configured to display output from the scanner system. The display may for example display a 2D rendering of the generated digital 3D model. In some embodiments, the display is configured for displaying the virtual image as disclosed herein or displaying a video with a given frame rate based on a plurality of continuously generated virtual images. The video may also be referred to as a “live view” of the 3D scanner, and it may be displayed together with the rendered 3D model on the display. The viewpoint of the “live view” may correspond to the view as seen along the optical axis of the projector unit. Input devices may also be connected to the I/O interface. Examples of such input devices include a keyboard and a mouse, which allow user interaction with the scanner system. A network interface may further be part of the scanner system in order to allow it to be connected to an appropriate computer network so as to receive and transmit data (such as scan data and images) from and to other computing devices or systems. The processor(s), volatile memory, hard disc drive, I/O interface, and network interface, may be connected together by a bus.

The 3D scanner system is preferably configured for receiving data from the intraoral 3D scanner, either directly from the intraoral 3D scanner or via a computer network such as a wireless network. The data may comprise images, processed images, 3D data, point clouds, sets of data points, or other types of data. The data may be transmitted/received using a wireless connection, a wired connection, and/or combinations thereof. The scanner system may be configured for performing any of the computer-implemented methods disclosed herein, either fully or partly. In some embodiments, the scanner system is configured for receiving data, such as point clouds, from the intraoral 3D scanner and then subsequently perform the steps of reconstruction and rendering a digital 3D model of the scanned three-dimensional (3D) object. Rendering may be understood as the process of generating one or more images from three-dimensional data. The scanner system may comprise computer memory for storing a computer program, said computer program comprising computer-executable instructions, which when executed, causes the scanner system to carry out the method of refining a 3D surface.

The virtual image may be generated in a variety of ways. In some embodiments, a virtual image is generated in a projector image plane by ray tracing camera rays from pixels in the camera images to the 3D surface, and then from the incidents of the 3D surface to the projector image plane. This method is further described in relation to FIG. 6.

In other embodiments, a volumetric model may be generated. A volumetric model may refer to a three-dimensional representation of an object. The model may store spatial information of the object by dividing the model into small volumetric units, often called voxels. Each voxel in the volumetric model may contain data about its properties, such as color, density, texture, or material composition. Thus, the scanned object may be discretized into a regular grid of voxels. The method may further comprise the step of rendering one or more virtual images from the volumetric model, e.g., using volume rendering techniques. As an example, the virtual image may be generated by ray tracing image pixels from the images into the volume defined by the volumetric model.

In other embodiments, the virtual image may be generated using neural radiance fields (NeRF), which is a technique in computer graphics and computer vision for modeling 3D geometry and appearance of objects or scenes from 2D images. It provides a way to represent complex and realistic scenes by training a neural network to approximate the volumetric scene representation based on a set of 2D images captured from different viewpoints. Unlike traditional geometric or voxel-based representations, NeRF models the scene as a continuous function that maps 3D spatial coordinates to radiance values (color and opacity) in a volumetric space. The trained neural network may be used to generate photorealistic renderings of the object from any desired viewpoint. This allows for the synthesis of virtual image(s) with novel view(s).

The cameras and projector unit of the intraoral 3D scanner may be arranged in a fixed predefined relationship relative to each other. As an example, the cameras may be arranged symmetrically around the projector unit. The cameras and projector unit may be mounted in a fixation unit for ensuring a fixed positional relationship between said units. An advantage of placing the cameras and projector unit in a fixed known relationship is that it provides a good and accurate platform for enabling a volumetric model to be generated by the 3D scanner system. As an example, the NeRF technique explained above assumes known camera positions and that the lighting is the same in the different images acquired by the cameras. An advantage of cameras having at least partially overlapping fields of view is that the amount of light in the images is similar; in particular, when said light is provided by a projector unit arranged in the center of the cameras.

### DETAILED DESCRIPTION OF THE DRAWINGS

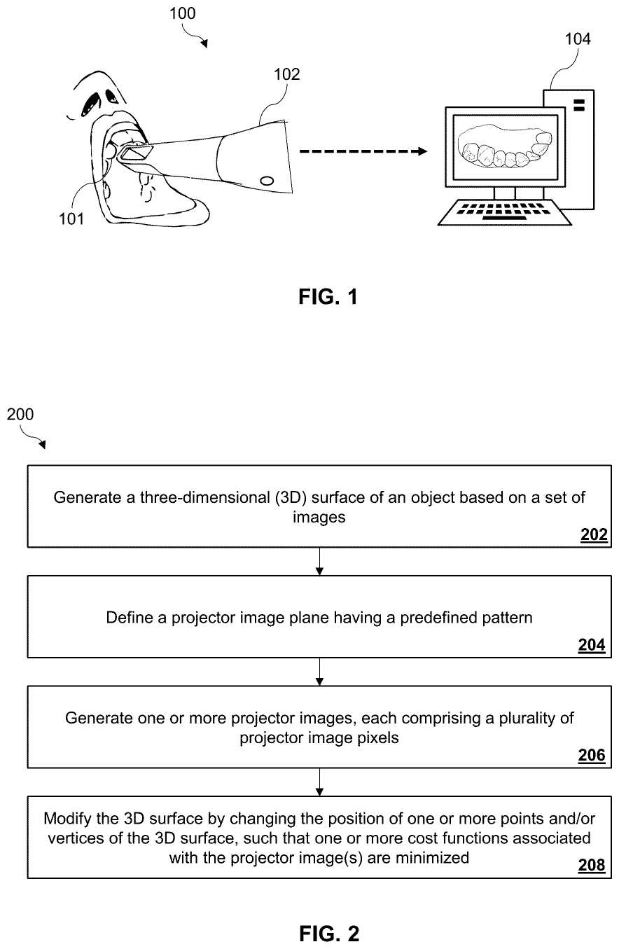

FIG. 1 shows a 3D scanner system 100 according to the present disclosure. The 3D scanner system is configured for generating a three-dimensional (3D) representation of an object 101, such as a dental object. As an example, the object 101 may be at least a part of the oral cavity including any of dentition, gingiva, retromolar trigone, hard palate, soft palate, and floor of the mouth, etc. In this embodiment, the 3D scanner system comprises an intraoral 3D scanner 102 for acquiring a set of images of the scanned object, e.g. within the oral cavity of a person. The 3D scanner system further comprises one or more processors for generating a three-dimensional (3D) representation of the scanned object based on the acquired images. In general, the 3D representation may only represent a part of the object surface, e.g. captured by the field of view of the intraoral 3D scanner 102. Such a 3D representation may also be referred to herein as a sub-scan or 3D surface. The processor(s) may be part of the 3D scanner 102, or they may be external to the intraoral 3D scanner, or a combination of the two, i.e. such that some processing is performed on the 3D scanner, and further processing is performed on a computer system 104. The intraoral 3D scanner may be configured to continuously, e.g., in real-time, acquire sets of images and generate one or more 3D surfaces and/or sub-scans based on said images. It may further be configured to continuously transmit, either wired or wirelessly, said sub-scans to a computer system 104. The sub-scans may be registered and stitched to each other to form a digital 3D model of the scanned object. Said 3D model may be displayed on a display, e.g. connected to the computer system.

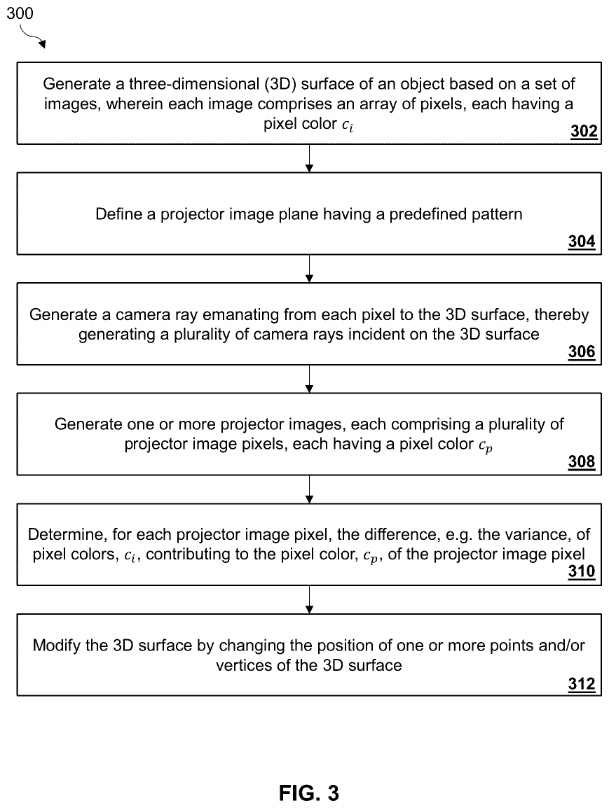

FIG. 2 shows a flowchart 200 according to an embodiment of the computer-implemented method disclosed herein. In step 202, a three-dimensional (3D) surface of an object is generated based on a set of images. In step 204, a projector image plane having a predefined pattern is defined. In step 206, one or more projector images, each comprising a plurality of projector image pixels, are generated. In step 208, the 3D surface is modified by changing the position of one or more points and/or vertices of the 3D surface, such that one or more cost functions associated with the projector image(s) are minimized.

FIG. 3 shows a flowchart 300 according to an embodiment of the computer-implemented method disclosed herein. In step 302, a three-dimensional (3D) surface of an object is generated, wherein each image comprises an array of pixels, each pixel having a pixel color cᵢ. In step 304, a projector image plane having a predefined pattern is defined. In step 306, a camera ray emanating from each pixel to the 3D surface is generated, thereby generating a plurality of camera rays incident on the 3D surface. In step 308, one or more projector image(s), each comprising a plurality of projector image pixels each having a pixel color cₚ, are generated. In step 310, the difference, e.g. the mean and/or variance, of the pixel colors, cᵢ, contributing to the pixel color, cₚ, of each projector image pixel is determined. In step 312, the 3D surface is modified by changing the position of one or more points and/or vertices of the 3D surface.

FIG. 4 shows a flowchart 400 according to an embodiment of the computer-implemented method disclosed herein. In step 402, a three-dimensional (3D) surface of an object is generated, wherein the 3D surface is generated based on a set of images obtained from two or more cameras, wherein the set of images comprises at least one image from each of the cameras, wherein each image comprises an array of pixels, each pixel having a pixel color cᵢ. In step 404, a projector image plane having a predefined pattern is defined. In step 406, a camera ray emanating from the pixel to the 3D surface is generated for each pixel in each image within the set of images, thereby generating a plurality of camera rays incident on the 3D surface. In step 408, one or more projector image(s), each comprising a plurality of projector image pixels, each having a pixel color cₚ, are generated, wherein the projector image(s) are generated by projecting each of the camera rays from the respective incidents on the 3D surface to the projector image plane. In step 410, the difference, e.g. the mean and/or variance of the pixel colors, cᵢ, contributing to the pixel color, cₚ, of each projector image pixel is determined. In step 412, the 3D surface is modified by changing the position of one or more points and/or vertices of the 3D surface, such that one or more cost functions associated with the projector image(s) are minimized. The method may further comprise the step of outputting a refined 3D surface based on the modified 3D surface. The refined 3D surface may be generated by the scanner system disclosed herein. A plurality of refined 3D surfaces may be registered in a common coordinate system and stitched together to form a 3D model of the object. The 3D model may be output to a display forming part of the scanner system.

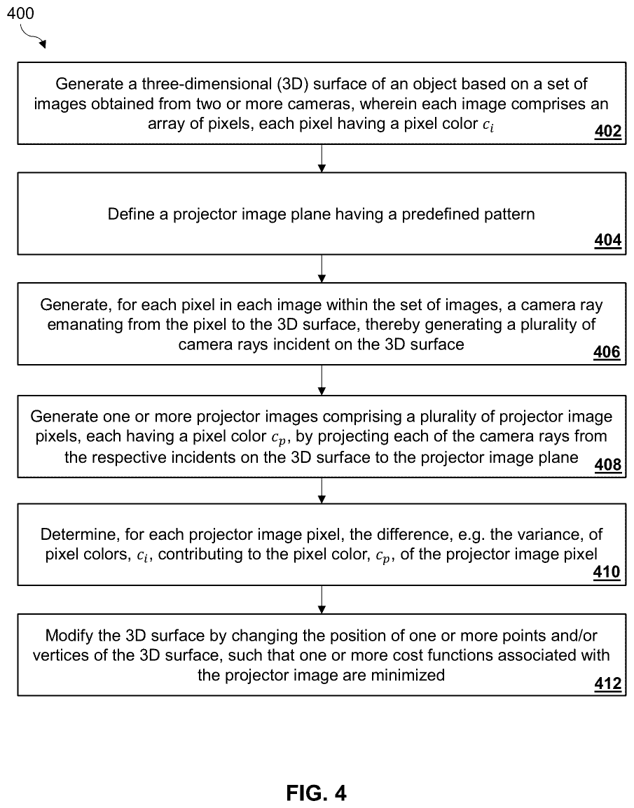

FIG. 5 shows a computer system 500 in which embodiments of the present disclosure, or portions thereof, may be implemented as computer-readable code. The computer system may encompass a range of components enabling data processing, storage, communication, and user interaction. The computer system described herein may comprise one or more processors 504, a communications interface 524, a hard disk drive 512, a removable storage drive 514, an interface 520, a main memory 508, a display interface 502, and a display 530. The one or more processor(s) 504 may be configured for executing one or more steps of the computer-implemented methods disclosed herein. The communications interface 524 may be configured to allow the computer system to communicate with external devices and networks. It may support various communication protocols, such as Ethernet, Wi-Fi, or Bluetooth, enabling the exchange of data and facilitating connectivity with other devices. The hard disk drive 512 may be configured to provide non-volatile storage for the computer system. It may store software programs, operating system files, user data, and other files in a medium, such as a magnetic medium. The hard disk drive 512 may ensure persistent storage, allowing data to be retained even when the system is powered off. The removable storage drive 514, such as a CD/DVD drive or USB port, may be configured to provide the capability of the computer system to read from and/or write to a removable storage unit 518. This allows users to access external storage devices, such as optical discs or USB flash drives, and transfer data to and from the computer system. The interface 520 may be configured to connect various external devices, such as keyboards, mice, printers, scanners, or audio devices, to the computer system.

FIG. 6 shows an exemplary illustration of an aspect of the presently disclosed computer-implemented method. The figure shows a camera ray emanating from a pixel in a given image acquired by a camera, wherein the camera ray is incident on the 3D surface, here exemplified as a mesh. The figure further shows the projection of the point given by the intersection with the surface, wherein the point is projected into a projector image in a projector plane. The method may comprise the step of generating such a projector image for each of the images in the set of images. Thus, multiple pairs of images may be generated, each pair comprising a camera image and a projector image. The projector image may be a virtual image. Thus, the disclosed method may comprise the step of generating a virtual image by projecting each of the camera rays from the respective incidents on the 3D surface to a projector image plane. The 3D scanner may be configured for continuously generating virtual images during a scanning session, such that a video with a given frame rate may be output e.g. to a display. The virtual image may be understood as an aggregated image generated based on one or more of the images in the set of images. In some embodiments, the virtual image represents a novel view compared to the views/orientations of the cameras of the 3D scanner. Thus, the virtual image may have a different location and/or orientation compared to the images acquired by the cameras. In some embodiments, the virtual image corresponds to a view seen along the optical axis of the projector unit. The novel view may coincide with the projector image plane. Given the 3D surface, the method may comprise the step of considering variations of the surface by moving vertices in the mesh further from or closer to a defined projector plane to generate a total of N surfaces or meshes. The method may further comprise the step of determining, for a plurality of image pixels, preferably for each image pixel in each of the images, intersections between the surface and camera rays associated with the image pixels. The method may further comprise the step of projecting the intersection points onto the projector plane, giving rise to N projector plane images per camera image. The method further comprise the step of calculating the mean and/or variance of the pixels contributing to the projector plane image(s) for each of the N versions of the 3D surface.

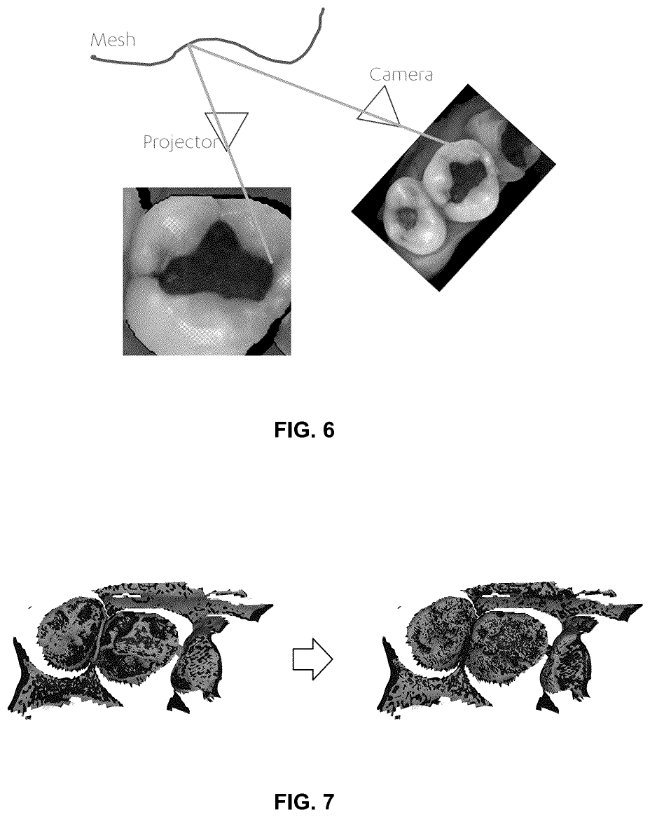

FIG. 7 shows a generated 3D surface, i.e., a single sub-scan, before and after modification/refinement of the surface. The figure shows the ground truth in black corresponding to the true 3D surface of the object, and the generated 3D surface in grey. The left image corresponds to the two surfaces before any refinement, and the right image corresponds to the two surfaces after running the presently disclosed computer-implemented method. As seen from the left image, before refinement, larger “islands” of connected points exist, wherein the depth is offset from the ground truth; either the points are closer or farther away compared to the ground truth. As seen from the right image, after refinement, said “islands” are much smaller in area, thus implying that there is less bias in terms of depth in the refined 3D surface. Specifically, the depth of the points seems to alternate to a larger extent between having a too small depth and too large depth as opposed to being biased towards any of the two. In other words, points having a too large or too small depth are connected in smaller groups of connected points after the refinement process.

### FURTHER DETAILS OF THE INVENTION

1. A computer-implemented method comprising the steps of:
   generating a three-dimensional (3D) surface of an object, wherein the 3D surface is generated based on a set of images obtained from two or more cameras, wherein the set of images comprises at least one image from each of the cameras, wherein each image comprises an array of pixels, each pixel having a pixel color cᵢ;
   generating, for each image, a camera ray emanating from each pixel to the 3D surface, thereby generating a plurality of camera rays incident on the 3D surface;
   generating, for each image, a projector image by projecting each of the camera rays from the respective incidents on the 3D surface to a predefined projector image plane, wherein the projector image comprises a plurality of projector image pixels each having a pixel color cₚ based on the pixel colors cᵢ;
   determining, for each projector image pixel, a metric expressing the difference of the pixel colors cₚ across the projector images; and
   generating a modified 3D surface by translating one or more points and/or vertices of the 3D surface, such that one or more cost functions associated with the projector image pixels are minimized.
3. The method according to item 1, wherein the method further comprises the step of generating an averaged projector image from the projector images.
4. The method according to any of the preceding items, wherein each of the projector images comprises a pattern having a plurality of pattern features.
5. The method according to any of the items 3 or 4, wherein the method further comprises the step of calculating a pixel-wise product of the pattern and the averaged projector image.
6. The method according to any of the preceding items, wherein the method further comprises the step of generating one or more cost functions associated with the projector image pixels.
7. The method according to item 6, wherein at least one cost function is generated for each pattern feature in the pattern.
8. The method according to any of the items 6 or 7, wherein the cost function comprises a weighted sum of the metric and the pixel-wise product.
9. The method according to any of the preceding items, wherein the metric is selected from the group of: standard deviation, variance, coefficient of variation, or combinations thereof.
10. The method according to any of the preceding items, wherein the pixel colors cᵢ associated with a given projector image pixel are weighted differently.
11. The method according to any of the preceding items, wherein the 3D surface is represented as any of: a polygon mesh, a signed distance field, a voxel grid, an implicit surface function, or a B-spline surface.
12. The method according to any of the preceding items, wherein the 3D surface is a signed distance field defined relative to a voxel grid comprising a plurality of voxels.
13. The method according to item 12, wherein the 3D surface is modified by changing the values of the signed distance field in predefined positions within the voxel grid.
14. The method according to any of the preceding items, wherein the 3D surface is a polygon mesh comprising a plurality of points and/or vertices.
15. The method according to any of the preceding items, wherein the position of each point or vertex on the 3D surface is varied and a position for each point or vertex is selected to minimize the value of the cost function in that point or vertex.
16. The method according to item 15, wherein the position is constrained to move along projector rays emanating from the projector image pixels.
17. The method according to any of the preceding items, wherein the points and/or vertices of the 3D surface are translated along projector rays emanating from the projector image pixels.
18. The method according to any of the preceding items, wherein the minimum value of the cost functions are determined using an iterative approach, such as Newton's method or gradient descent methods.
19. The method according to any of the preceding items, wherein the minimum value of the cost functions is determined by iteratively changing the positions of the points and/or vertices until a minimum of the metric is obtained.
20. The method according to any of the preceding items, wherein the projector image plane is similar for all the projector images, such that all projector images lie in the same plane.
21. The method according to any of the preceding items, wherein the set of images comprises one image from each of the cameras, such that the number of images in the set of images corresponds to the number of cameras.
22. A computer-implemented method comprising the steps of:
   generating a three-dimensional (3D) surface of an object, wherein the 3D surface is generated based on a set of images obtained from two or more cameras, wherein the set of images comprises at least one image from each of the cameras, wherein each image comprises an array of pixels, each pixel having a pixel color cᵢ;
   defining a projector image plane having a predefined pattern;
   generating, for each pixel in each image within the set of images, a camera ray emanating from the pixel to the 3D surface, thereby generating a plurality of camera rays incident on the 3D surface;
   generating a projector image comprising a plurality of projector image pixels, each having a pixel color cₚ, wherein the projector image is generated by projecting each of the camera rays from the respective incidents on the 3D surface to the projector image plane;
   determining, for each projector image pixel, the variance of pixel colors, cᵢ, contributing to the pixel color, cₚ, of said projector image pixel; and
   modifying the 3D surface by changing the position of one or more points and/or vertices of the 3D surface, such that one or more cost functions associated with the projector image pixels are minimized.
23. A data processing system comprising one or more processors configured to perform the steps of the method according to any of the items 1-22.
24. A computer program product comprising instructions which, when the program is executed by a computer, cause the computer to carry out the steps of the method according to any of the items 1-22.
25. A computer-readable storage medium comprising instructions which, when executed by a computer, cause the computer to carry out the steps of the method according to any of the items 1-22.
26. A computer-readable data carrier having stored thereon the computer program product of item 24.
27. A 3D scanner system comprising:
   an intraoral 3D scanner comprising:
      a projector unit comprising a light source and a pattern generating element for structuring light from the light source into a pattern to be projected onto a surface of an object;
      two or more cameras operatively connected to the projector unit, wherein each camera comprises an image sensor for acquiring one or more two-dimensional images, each image comprising an array of pixels, each pixel having a pixel color cᵢ; and
      one or more processors operatively connected to the intraoral 3D scanner, said processors configured for performing the steps of the method according to any of the items 1-22.
28. A 3D scanner system comprising:
   an intraoral 3D scanner comprising:
      a projector unit comprising a light source and a pattern generating element for structuring light from the light source into a pattern to be projected onto a surface of an object;
      two or more cameras operatively connected to the projector unit, the cameras being configured for acquiring a set of images, wherein the set of images comprises an image from each camera, wherein each image comprises an array of pixels, each pixel having a pixel color cᵢ;
   one or more processors operatively connected to the intraoral 3D scanner, said processors configured for:
      generating a three-dimensional (3D) surface of the object based on the set of images obtained from the cameras, wherein the 3D surface comprises a plurality of points and/or vertices; and
      generating a refined 3D surface by solving an optimization problem, wherein points and/or vertices in the 3D surface are repositioned such that a metric based on the differences in the pixel colors cᵢ across the images is minimized.
29. A 3D scanner system comprising:
   an intraoral 3D scanner comprising:
      a projector unit comprising a light source and a pattern generating element for structuring light from the light source into a pattern to be projected onto a surface of an object;
      two or more cameras operatively connected to the projector unit, the cameras being configured for acquiring a set of images, wherein the set of images comprises an image from each camera;
   one or more processors operatively connected to the intraoral 3D scanner, said processors configured for:
      generating a three-dimensional (3D) surface of the object based on the set of images obtained from the cameras; and
      generating, for a plurality of pixels in one or more images within the set of images, a camera ray emanating from the pixel to the 3D surface, thereby generating a plurality of camera rays incident on the 3D surface; and
      generating a virtual image by projecting each of the camera rays from the respective incidents on the 3D surface to a projector image plane.
30. The 3D scanner system according to any of the items 27-29, wherein a camera ray is generated for each pixel in each of the images within the set of images.
31. The 3D scanner system according to any of the items 27-30, wherein a given image pixel in the virtual image has a given color based on contributions from pixels in two or more images obtained from different cameras.
32. The 3D scanner system according to any of the items 27-31, wherein the location of the virtual image plane is different from the location of the image planes belonging to the images in the set of images.
33. The 3D scanner system according to any of the items 27-32, wherein each camera has a given field of view, wherein the field of view of the cameras overlap such that they image approximately the same scene or object.
34. The 3D scanner system according to any of the items 27-33, wherein the position and/or orientation of the virtual image represents a novel view compared to the views/orientations of the cameras.
35. The 3D scanner system according to any of the items 27-34, wherein the novel view corresponds to a view seen along the optical axis of the projector unit.
36. The 3D scanner system according to item 35, wherein the novel view coincides with the projector image plane.
37. The 3D scanner system according to any of the items 27-36, wherein the pattern generating element is a mask, wherein the projector image plane coincides with the location of the mask.
38. The 3D scanner system according to any of the items 27-37, wherein the virtual image is generated or updated continuously in real time during operation of the intraoral 3D scanner, such that a video with a given frame rate is provided.
39. The 3D scanner system according to any of the items 27-38, wherein the 3D scanner system further comprises a display configured for displaying the virtual image and/or the video.
40. The 3D scanner system according to any of the items 27-39, wherein the light source of the projector unit is configured for emitting light in a visible wavelength range.
41. The 3D scanner system according to any of the items 27-40, wherein the virtual image is a color image generated based on visible light reflected from the surface of the object.
42. The 3D scanner system according to any of the items 27-41, wherein the 3D scanner system further comprises one or more additional light sources.
43. The 3D scanner system according to any of the items 27-42, wherein the 3D scanner system further comprises an infrared light source configured for emitting infrared (IR) light or near-infrared (NIR) light.
44. The 3D scanner system according to item 43, wherein the IR light has a wavelength or a range of wavelengths selected from the range of about 700 nm to about 1.5 μm.
45. The 3D scanner system according to any of the items 43-44, wherein the virtual image is generated based on infrared light reflected from the object.
46. A 3D scanner system comprising:
   an intraoral 3D scanner comprising:
      a projector unit comprising a light source and a pattern generating element for structuring light from the light source into a pattern to be projected onto a surface of an object;
      two or more cameras operatively connected to the projector unit, wherein each camera comprises an image sensor for acquiring one or more two-dimensional images, each image comprising an array of pixels, each pixel having a pixel color cᵢ;
   one or more processors operatively connected to the intraoral 3D scanner, said processors configured for:
      generating a three-dimensional (3D) surface of the object based on a set of images obtained from the cameras, wherein the set of images comprises at least one image from each of the cameras, wherein each image comprises an array of pixels, each pixel having a pixel color cᵢ;
      generating, for each image, a camera ray emanating from each pixel to the 3D surface, thereby generating a plurality of camera rays incident on the 3D surface;
      generating, for each image, a projector image by projecting each of the camera rays from the respective incidents on the 3D surface to a predefined projector image plane, wherein the projector image comprises a plurality of projector image pixels each having a pixel color cᵢ;
      determining, for each projector image pixel, a metric expressing the difference of the pixel colors cᵢ across the projector images; and
      generating a modified 3D surface by translating one or more points and/or vertices of the 3D surface, such that one or more cost functions associated with the projector image pixels are minimized.
47. The 3D scanner system according to any of the items 27-46, wherein the points and/or vertices in the 3D surface are repositioned in an iterative approach, wherein the value of the metric is determined for all iterations.
48. The 3D scanner system according to any of the items 27-47, wherein the intraoral 3D scanner comprises four or more cameras.
49. The 3D scanner system according to any of the items 27-48, wherein the cameras are synchronized such that they acquire images approximately simultaneously.
50. The 3D scanner system according to any of the items 27-49, wherein the set of images comprise one image from each camera.
51. The 3D scanner system according to any of the items 27-50, wherein the processor(s) are configured to determine image features in the images within the set of images using a neural network.
52. The 3D scanner system according to any of the items 27-51, wherein the neural network is implemented on a specialized integrated circuit such as a neural processing unit.
53. The 3D scanner system according to any of the items 27-52, wherein the projector unit comprises a light source for emitting white light.
54. The 3D scanner system according to any of the items 27-53, wherein the projector unit comprises a light source for emitting unpolarized light.
55. The 3D scanner system according to any of the items 27-54, wherein the pattern is a polygonal pattern comprising a plurality of polygons in a repeating pattern, said polygons selected from the group of: triangles, rectangles, squares, pentagons, hexagons, and/or combinations thereof.
56. The 3D scanner system according to any of the items 27-55, wherein the pattern is a checkerboard pattern or a distribution of discrete unconnected spots of light.
57. The 3D scanner system according to any of the items 27-56, wherein the intraoral 3D scanner further comprises one or more additional light sources for emitting light in an infrared range, such as light having a wavelength between 700 nm and 1.5 μm.
58. The 3D scanner system according to any of the items 27-57, wherein the intraoral 3D scanner further comprises one or more additional light sources for emitting light in an ultraviolet range, such as light having a wavelength between 315 nm and 400 nm.
59. The 3D scanner system according to any of the items 27-58, wherein the image sensor is a color image sensor.
60. The 3D scanner system according to any of the items 27-59, wherein the image sensor comprises a color filter array, such as a Bayer filter.

Although some embodiments have been described and shown in detail, the disclosure is not restricted such details, but may also be embodied in other ways within the scope of the subject matter defined the following claims. In particular, it is to be understood that other embodiments may be utilized, and structural and functional modifications may be made with-out departing from the scope of the present disclosure. Furthermore, the skilled person would find it apparent that unless an embodiment specifically presented only as an alternative, different disclosed embodiments may be combined to achieve a specific implementation and such specific implementation is within the scope of the disclosure.

1. A computer-implemented method comprising the steps of:
generating a three-dimensional (3D) surface of an object, wherein the 3D surface is generated based on a set of images obtained from two or more cameras, wherein the set of images comprises at least one image from each of the cameras, wherein each image comprises an array of pixels, each pixel having a pixel color cᵢ;
generating, for each image, a camera ray emanating from each pixel to the 3D surface, thereby generating a plurality of camera rays incident on the 3D surface;
generating, for each image, a projector image by projecting each of the camera rays from the respective incidents on the 3D surface to a predefined projector image plane, wherein the projector image comprises a plurality of projector image pixels each having a pixel color cₚ based on the pixel colors cᵢ;
determining, for each projector image pixel, a metric expressing the difference of the pixel colors cₚ across the projector images; and
generating a modified 3D surface by translating one or more points and/or vertices of the 3D surface, such that one or more cost functions associated with the projector image pixels are minimized.

2. The method according to claim Error! Reference source not found., wherein the method further comprises the step of generating an averaged projector image from the projector images.

3. The method according to claim 1, wherein each of the projector images comprises a pattern having a plurality of pattern features.

4. The method according to claim 2, wherein the method further comprises the step of calculating a pixel-wise product of the pattern and the averaged projector image.

5. The method according to claim 1, wherein the method further comprises the step of generating one or more cost functions associated with the projector image pixels.

6. The method according to claim 5, wherein at least one cost function is generated for each pattern feature in the pattern.

7. The method according to claim 5, wherein the cost function comprises a weighted sum of the metric and the pixel-wise product.

8. The method according to claim 1, wherein the metric is selected from the group of: standard deviation, variance, coefficient of variation, or combinations thereof.

9. The method according to claim 1, wherein the pixel colors cᵢ associated with a given projector image pixel are weighted differently.

10. The method according to claim 1, wherein the 3D surface is represented as any of: a polygon mesh, a signed distance field, a voxel grid, an implicit surface function, or a B-spline surface.

11. The method according to claim 1, wherein the 3D surface is a signed distance field defined relative to a voxel grid comprising a plurality of voxels.

12. The method according to claim 11, wherein the 3D surface is modified by changing the values of the signed distance field in predefined positions within the voxel grid.

13. The method according to claim 1, wherein the 3D surface is a polygon mesh comprising a plurality of points and/or vertices.

14. The method according to claim 1, wherein the position of each point or vertex on the 3D surface is varied and a position for each point or vertex is selected to minimize the value of the cost function in that point or vertex.

15. The method according to claim 14, wherein the position is constrained to move along projector rays emanating from the projector image pixels.

16. The method according to claim 1, wherein the points and/or vertices of the 3D surface are translated along projector rays emanating from the projector image pixels.

17. The method according to claim 1, wherein the minimum value of the cost functions are determined using an iterative approach, such as Newton's method or gradient descent methods.

18. The method according to claim 1, wherein the minimum value of the cost functions is determined by iteratively changing the positions of the points and/or vertices until a minimum of the metric is obtained.

19. The method according to claim 1, wherein the projector image plane is similar for all the projector images, such that all projector images lie in the same plane.

20. The method according to claim 1, wherein the set of images comprises one image from each of the cameras, such that the number of images in the set of images corresponds to the number of cameras.

21. A 3D scanner system comprising:
an intraoral 3D scanner comprising:
a projector unit comprising a light source and a pattern generating element for structuring light from the light source into a pattern to be projected onto a surface of an object;
two or more cameras operatively connected to the projector unit, the cameras being configured for acquiring a set of images, wherein the set of images comprises an image from each camera, wherein each image comprises an array of pixels, each pixel having a pixel color cᵢ;
one or more processors operatively connected to the intraoral 3D scanner, said processors configured for:
generating a three-dimensional (3D) surface of the object based on the set of images obtained from the cameras, wherein the 3D surface comprises a plurality of points and/or vertices; and
generating a refined 3D surface by solving an optimization problem, wherein points and/or vertices in the 3D surface are repositioned such that a metric based on the differences in the pixel colors cᵢ across the images is minimized.

22. The 3D scanner system according to claim 21, wherein a camera ray is generated for each pixel in each of the images within the set of images.

23. The 3D scanner system according to claim 21, wherein a given image pixel in the virtual image has a given color based on contributions from pixels in two or more images obtained from different cameras.

24. The 3D scanner system according to claim 21, wherein the location of the virtual image plane is different from the location of the image planes belonging to the images in the set of images.

25. The 3D scanner system according to claim 21, wherein each camera has a given field of view, wherein the field of view of the cameras overlap such that they image approximately the same scene or object.

26. The 3D scanner system according to claim 21, wherein the position and/or orientation of the virtual image represents a novel view compared to the views/orientations of the cameras.

27. The 3D scanner system according to claim 21, wherein the novel view corresponds to a view seen along the optical axis of the projector unit.

28. The 3D scanner system according to claim 27, wherein the novel view coincides with the projector image plane.

29. The 3D scanner system according to claim 21, wherein the pattern generating element is a mask, wherein the projector image plane coincides with the location of the mask.

30. The 3D scanner system according to claim 21, wherein the virtual image is generated or updated continuously in real time during operation of the intraoral 3D scanner, such that a video with a given frame rate is provided.

31. The 3D scanner system according to claim 21, wherein the 3D scanner system further comprises a display configured for displaying the virtual image and/or the video.

32. The 3D scanner system according to claim 21, wherein the light source of the projector unit is configured for emitting light in a visible wavelength range.

33. The 3D scanner system according to claim 21, wherein the virtual image is a color image generated based on visible light reflected from the surface of the object.

34. The 3D scanner system according to claim 21, wherein the 3D scanner system further comprises one or more additional light sources.

35. The 3D scanner system according to claim 21, wherein the 3D scanner system further comprises an infrared light source configured for emitting infrared (IR) light or near-infrared (NIR) light.

36. The 3D scanner system according to claim 35, wherein the IR light has a wavelength or a range of wavelengths selected from the range of about 700 nm to about 1.5 μm.

37. The 3D scanner system according to claim 21, wherein the virtual image is generated based on infrared light reflected from the object.
